(19) United States
(12) Patent Application Publication
(10) Pub. No.: US 2008/0198823 A1
(43) Pub. Date: Aug. 21, 2008

(54) METHOD FOR ESTABLISHING A WIRELESS LOCAL AREA NETWORK LINK

(76) Inventors: Duan-Ruei Shiu, Taipei City (TW); Chen-Chung Ho, Taipei City (TW); Li-Pin Yeh, Taipei City (TW); Chia-Hui Han, Taipei City (TW); Chi-Huan Tsai, Taipei City (TW); Chia-Yu Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/031,711

(22) Filed: Feb. 15, 2008

(30) Foreign Application Priority Data
Feb. 16, 2007 (TW) 096106265

(51) Int. Cl. H04Q 7/24

(52) U.S. Cl. 370/338

(57) ABSTRACT

A user can link a station to an access point by triggering buttons of the station and the access point respectively. After the buttons are triggered, the station scans the SSID of the access point. The access point updates SSID and sends out the new SSID to the station in response to the station's request. Then, the station generates a security key according to the new SSID and links the access point according to the new SSID and the security key so as to establish a WLAN link.

### BACKGROUND OF THE INVENTION

1. Field of the Invention

The present invention relates to a method for establishing a wireless local area network link, and more particularly, to a method for establishing a wireless local area network link between a station and an access point.

2. Description of the Prior Art

Wireless local area networks have experienced rapid development in commercial and personal applications. Although a WLAN is a convenient and mobile tool, its user has to work through a complicated configuration procedure to establish a link between a station and an access point. The configuration procedure is a big headache for a novice.

In the prior art, a number of WLAN configuration procedures have been introduced to establish a WLAN link between a station and an access point. Some of the configuration procedures are as follows:

1. A user inputs predetermined configuration parameters to the station and the access point, but it is very inconvenient for the user.

2. A temporary link is established between the station and the access point with a preset service set identifier (SSID) and a preset security key, then the SSID and the security key are updated. However, since a temporary link can be established between the station and the access point with the preset SSID and the preset security key, the link is unsafe before the preset SSID and the security key are updated.

3. The user inputs the security key after the configuration procedure is initiated and the indicator on the access point indicates that the security key can be input.

As shown above, prior art fails to teach any convenient and secure method for establishing a WLAN link.

### SUMMARY OF THE INVENTION

An embodiment of the present invention provides a method for establishing a WLAN (wireless local area network) link. The method comprises an access point updating an SSID (Service Set Identifier) of the access point to generate a new SSID, a station sending out a probe request for the SSID of the access point, the access point sending a probe response containing the new SSID out to the station in response to the request of the station, the station generating a security key according to the new SSID, and establishing a WLAN link between the station and the access point according to the new SSID and the security key.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow diagram of establishing a WLAN link according to an embodiment of the present invention.

FIG. 2 is a flow diagram of configuring the station in FIG. 1 according to the embodiment of the present invention.

### DETAILED DESCRIPTION

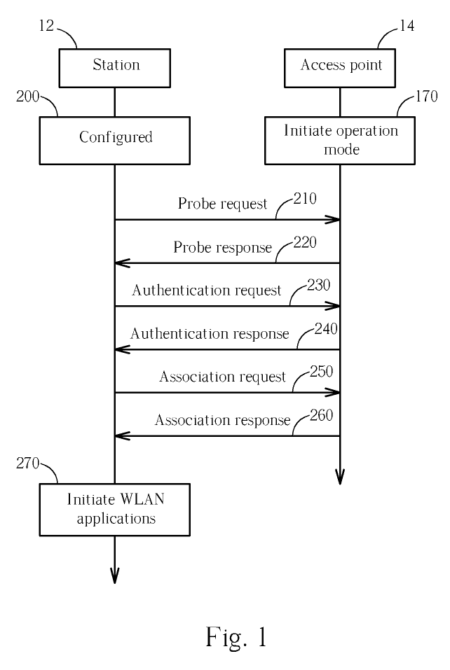

Please refer to FIG. 1. FIG. 1 is a flow diagram of a procedure of establishing a WLAN link according to an embodiment of the present invention. A WLAN system comprises a station 12 and an access point 14. The station 12 can be a personal computer, notebook, network telephone or other electronic device linkable to a network. The access point 14 is a WLAN base station. The WLAN system may also comprise other stations and access points. First a user turns on the power of the station 12 and the access point 14, if a WLAN link between the station 12 and the access point 14 has been established, the status of the station 12 would be “configured”, and the access point 14 would enter into an operation mode. Then the station 12 would log onto the access point 14 with an SSID and security key according to a linking procedure defined by the IEEE 802.11 standard. The SSID of the access point 14 is determined in a configuration mode. The SSID has a prefix, a media access control (MAC) address and a nonce. In the operation mode, the access point 14 hides its SSID. This has following advantages:

1. The user of the station 12 does not need to know the SSID of the access point 14, nor does he need to enter the SSID of the access point 14 from the station 12.

2. The SSID of the access point 14 is hidden. Even if a hacker intercepts data envelopes transferred between the station 12 and the access point 14, the SSID of the access point 14 cannot be easily reinstated. Thus the WLAN system is quite secure.

Further in this embodiment, the security key is generated by a one-way hash function according to the SSID of the access point 14. Thus the station 12 and the access point 14 must use the same one-way hash function. The one-way hash function can be predefined in the station 12 and the access point 14 or can be defined by the user before linking the station 12 and the access point 14. But for security reasons, the one-way hash function must only be accessible by authorized personnel.

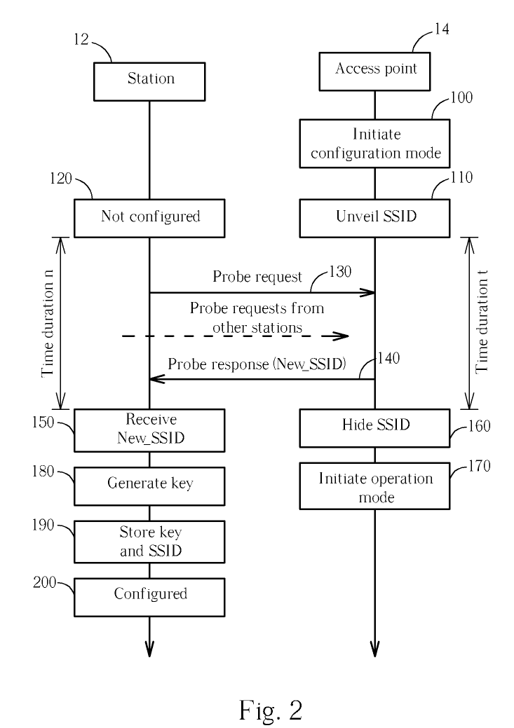

Please refer to FIG. 2. FIG. 2 is a flow diagram of configuring the station 12 according to the embodiment of the present invention. As described above, before establishing a WLAN link between the station 12 and the access point 14, the access point 14 should enter into a configuration mode to initiate a configuration procedure. For instance, a button of the access point 14 should be triggered or a button of a window for controlling the access point 14 can be triggered to start the configuration procedure. When the configuration procedure is initiated, the access point 14 can start timing. If the station 12 is not configured within a first predetermined time (time duration t), the access point 14 will automatically enter into the operation mode to avoid an intrusion of a hacker. In the configuration mode, the access point 14 will generate a new nonce, a prefix, and a MAC address of the access point 14 to form a new SSID. Then the new SSID will be unveiled until the station 12 is configured or the first predetermined time (time duration t) has elapsed. During the time duration t, the button on the window for controlling the station 12 is triggered to set the status of the station 12 as “not configured”, and the configuration procedure of the station 12 is initiated. Once the configuration procedure is initiated, the station 12 will output a probe request to the access point 14, then the access point 14 will output a probe response to the station 12 and the station 12 can receive the new SSID from the probe response. Since the new SSID includes the prefix, the MAC address and the new nonce of the access point 14, the station 12 can identify the access point 14 from the prefix, and input the MAC address and the new nonce to the one-way hash function H(x) to generate the security key. When the station 12 detects a plurality of linkable access point 14, the station 12 will try to link the access point 14 with the greatest RSSI (Received Signal Strength Indication).

If the station 12 is unable to be configured within a second predetermined time (time duration n), the station 12 will return to a previous state. For example, if the station 12 is originally not configured, then the station 12 will return to the “not configured” status. If the station 12 is originally configured, then the station 12 will return to the “configured” status.

After the station 12 determines which access point 14 to link, the station 12 will store the SSID and security key of the determined access point 14, and the determined access point 14 will enter into the operation mode. When a plurality of stations 12 are configuring at the same time, the configurations should be completed in the first predetermined time (time duration t) because the SSID of the access point 14 will be hidden when the first predetermined time has elapsed.

Please refer to FIGS. 1 and 2 again. FIGS. 1 and 2 describe how to establish a WLAN link according to the present invention.

First phase (configuration procedure, shown in FIG. 2):

Step 100: trigger a button to initiate the configuration mode of the access point 14;

Step 110: turn off the function to hide the SSID of the access point 14;

Step 120: trigger a button to set the status of the station 12 as “not configured”;

Step 130: the station 12 sends out a probe request to the access point 14;

Step 140: the access point 14 updates its SSID, and sends out the new SSID to the station 12 in a probe response, the new SSID contains the prefix, MAC address and new nonce.

Step 150: the station 12 receives the new SSID from the probe response with the greatest RSSI;

Step 160: initiate the function to hide the SSID of the access point 14;

Step 170: initiate the operation mode of the access point;

Step 180: the station 12 generates a security key according to the new SSID, the security key is a one-way hash function of the MAC address and new nonce of the new SSID;

Step 190: the station 12 stores the new SSID and the security key;

Step 200: set the status of the station 12 as “configured”.

Second phase (operation procedure, shown in FIG. 1):

Step 210: the station 12 sends out a probe request to the access point 14;

Step 220: the access point 14 sends out a probe response to the station 12;

Step 230: the station 12 sends out an authentication request to the access point 14;

Step 240: the access point 14 sends out an authentication response to the station 12;

Step 250: the station 12 sends out an association request to the access point 14;

Step 260: the access point 14 sends out an association response to the station 12;

Step 270: Upon the completion of the WLAN link, initiate the WLAN applications.

In conclusion, in an embodiment of the present invention, a WLAN link can be easily established by triggering buttons of the access point and the station. After triggering the buttons, the station scans the SSID of the access point, the access point updates its SSID, and sends out the new SSID to the station in response to the station's request. Then the station generates a security key according to the new SSID, and establish a WLAN link with the access point according to the new SSID and the security key. The WLAN link between the station and the access point is established without the user's involvement. For example, the user does not need to input a copious password or respond to flashing indicators. Thus is very convenient for the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for establishing a WLAN (wireless local area network) link comprising:
an access point updating an SSID (Service Set Identifier) of the access point to generate a new SSID;
a station sending out a probe request for the SSID of the access point;
the access point sending a probe response containing the new SSID out to the station in response to the request of the station;
the station generating a security key according to the new SSID; and
establishing a WLAN link between the station and the access point according to the new SSID and the security key.

2. The method of claim 1 further comprising triggering a button for initiating a configuration mode of the access point before the station sends out the probe request.

3. The method of claim 1 further comprising turning off a function for hiding the SSID of the access point before the station sends out the probe request.

4. The method of claim 1 further comprising triggering a button to set a status of the station as “not configured” before the station sends out the probe request.

5. The method of claim 1 further comprising after the access point updates the SSID and sends out the new SSID to the station, turning on a function to hide the new SSID of the access point.

6. The method of claim 1 further comprising after the access point updates the SSID and sends out the new SSID to the station, initiating an operation mode of the access point.

7. The method of claim 1 further comprising after the access point updates the SSID and sends out the new SSID to the station, the station receiving the probe response according to RSSI (Received Signal Strength Indication) of the probe response.

8. The method of claim 1 wherein generating the new SSIS is generating the new SSID comprising a prefix, MAC (Media Access Control) address, and new nonce.

9. The method of claim 8 wherein the station generating a security key according to the new SSID is the station generating a security key by inputting the MAC address and the new nonce of the access point into a one-way hash function.

10. The method of claim 1 further comprising the station storing the new SSID and security key after the station generates the security according to the new SSID.

11. The method of claim 10 further comprising set a status of the station as “configured” after the station stores the new SSID and security key.
